(19) United States
(12) Patent Application Publication
(10) Pub. No.: US 2026/0168317 A1
(43) Pub. Date: Jun. 18, 2026

(54) INTERFACE SYSTEM BETWEEN BUILDING AND TRANSPORT MOBILITY MEANS

(71) Applicants: Hyundai Motor Company, Seoul (KR); Kia Corporation, Seoul (KR)

(72) Inventors: Dae Young GWON, Hwaseong-si (KR); Ji Hyun SONG, Hwaseong-si (KR)

(73) Assignees: Hyundai Motor Company, Seoul (KR); Kia Corporation, Seoul (KR)

(21) Appl. No.: 19/225,981

(22) Filed: Jun. 2, 2025

(30) Foreign Application Priority Data
Dec. 16, 2024 (KR) 10-2024-0187452

(51) Int. Cl. E06B 5/00; E04H 6/18

(52) U.S. Cl. CPC E06B 5/00; E04H 6/18

(57) ABSTRACT

An interface system between a building and a transport mobility means includes a dome assembly disposed at the wall surface of the building to be positioned on a path of the guide rail, and including a plurality of dome portions that are joined together in an overlapping manner and rotate relatively, wherein the plurality of dome portions include respective opening portions, and when the opening portions of the plurality of dome portions are aligned according to a rotation position, the loading portion and the transport mobility means enter an internal space of the dome assembly through the aligned opening portions.

### CROSS REFERENCE TO RELATED APPLICATION

The present application claims priority to Korean Patent Application No. 10-2024-0187452, filed 16 Dec. 2024, the entire contents of which is incorporated herein for all purposes by this reference.

### BACKGROUND OF THE INVENTION

### Field of the Present Disclosure

The present disclosure relates to an interface system between a building and a transport mobility means, the interface system enabling the transport mobility means, such as vehicles, to move through a wall surface or the roof of the building and to enter the inside or the roof of the building.

### Description of the Related Art

In recent years, autonomous driving and electrification of vehicles have light-emitting diode (LED) to various transport means that differ from the existing vehicle forms. For example, as traditional vehicle forms diversify, the forms are assembled in various ways on the basis of their purpose, or a vehicle is joined with a drone device to be driven on the ground or move in the air.

In addition, with the increasing variety of vehicles, the concept of joining a vehicle with a building has been proposed, wherein the internal space of the vehicle provides one of the spaces of the building.

Various concepts of transport means including vehicles may be defined as transport mobility means. Such a transport mobility means is connected to a desired point at a building to allow entry into or exit from the transport mobility means directly from or to the building, and is docked on a desired point of the building to form one space of the building.

This requires technology that allows transport mobility means to freely move to various points at a building and to be mounted thereon or joined therewith.

The foregoing is intended merely to aid in the understanding of the background of the present disclosure, and is not intended to mean that the present disclosure falls within the purview of the related art that is already known to those skilled in the art.

### BRIEF SUMMARY

The present disclosure is directed to providing an interface system between a building and a transport mobility means, the interface system enabling the transport mobility means to freely move along a wall surface of the building and the transport mobility means to move to at any desired point of the building and to be joined.

It will be appreciated by persons skilled in the art that technical objectives to be achieved in the present disclosure are not limited to the above-mentioned technical objectives and other technical objectives which are not described herein will be clearly understood from the following description.

According to the present disclosure, there is provided an interface system between a building and a transport mobility means, the interface system including: a guide rail disposed at a wall surface of the building; a loading portion on which the transport mobility means is loaded, and configured to be slid along the wall surface of the building along the guide rail; and a dome assembly disposed at the wall surface of the building to be positioned on a path of the guide rail, and including a plurality of dome portions that are joined together in an overlapping manner and rotate relatively, wherein the plurality of dome portions include respective opening portions, and when the opening portions of the plurality of dome portions are aligned according to a rotation position, the loading portion and the transport mobility means enter an internal space of the dome assembly through the aligned opening portions.

In an exemplary embodiment of the present disclosure, the loading portion may be in the shape of a pallet supporting the transport mobility means, and may be connected to the guide rail in a rack and pinion manner so that the loading portion may be slid along the guide rail.

In an exemplary embodiment of the present disclosure, the guide rail may be in the shape of a groove recessed in the wall surface of the building.

In an exemplary embodiment of the present disclosure, the dome assembly may be provided at a point at which a plurality of guide rails intersect.

In an exemplary embodiment of the present disclosure, the plurality of dome portions included in the dome assembly may rotate relatively around the same rotation axis.

In an exemplary embodiment of the present disclosure, the plurality of dome portions forming the dome assembly may be provided with different radii and joined to the wall surface in an overlapping manner.

In an exemplary embodiment of the present disclosure, the plurality of dome portions forming the dome assembly may be in the shape of hemispheres, and the opening portions may be provided at sides of the dome portions.

In an exemplary embodiment of the present disclosure, when the plurality of dome portions rotate relatively to make directions of the opening portions cross each other, the internal space of the dome assembly may be closed.

In an exemplary embodiment of the present disclosure, at the wall surface of the building at which the dome assembly is provided, an entrance of the building may be provided.

In an exemplary embodiment of the present disclosure, when the transport mobility means is positioned in the internal space of the dome assembly, the transport mobility means may be allowed to move into or out of the building through the entrance of the building.

In an exemplary embodiment of the present disclosure, the guide rail may include a horizontal rail and a vertical rail, and the horizontal rail may be in the shape of a groove recessed in the wall surface of the building, and one side of the loading portion may be slid along the horizontal rail while inserted into the horizontal rail.

In an exemplary embodiment of the present disclosure, the guide rail may include a horizontal rail and a vertical rail, and the vertical rail may include a plurality of rail pipes spaced apart from the wall surface of the building, and the plurality of rail pipes may be arranged spaced apart from each other around the loading portion and connected to the loading portion.

In an exemplary embodiment of the present disclosure, the guide rail may include a horizontal rail and a vertical rail, and the horizontal rail and the vertical rail may be in the shape of grooves recessed in the wall surface of the building, and the horizontal rail and the vertical rail may intersect each other, and one side of the loading portion may be slid while inserted into the horizontal rail or the vertical rail.

In an exemplary embodiment of the present disclosure, the dome assembly may be provided to span a sidewall and a roof of the building together at an edge point of the roof of the building.

In an exemplary embodiment of the present disclosure, the dome assembly may be provided with a roof opening portion toward the roof of the building, and the transport mobility means may be allowed to move from the internal space of the dome assembly to the roof through the roof opening portion.

In an exemplary embodiment of the present disclosure, the dome assembly may include a fixed dome portion fixed at the building and a rotating dome portion rotatable while overlapped with the fixed dome portion.

In an exemplary embodiment of the present disclosure, the fixed dome portion may be provided to cover the sidewall and the roof of the building together, and may be provided with a sidewall opening portion toward the sidewall of the building and a roof opening portion toward the roof of the building.

In an exemplary embodiment of the present disclosure, the rotating dome portion may be in the shape of a hemisphere of which a side includes an opening portion, and when the opening portion of the rotating dome portion and the sidewall opening portion of the fixed dome portion are aligned, the transport mobility means may be allowed to enter the internal space of the dome assembly from the sidewall of the building.

According to the present disclosure, the interface system between a building and a transport mobility means enables the transport mobility means to move and to be slid along a wall surface of a building, moving the transport mobility means to any desired point.

Furthermore, the moved mobility means can enter the inside of the building, and reversely, the entered mobility means can exit to the outside of the building and then move to a point of a required building.

Furthermore, as the transport mobility means moves to the roof of the building, the transport mobility means may be joined with a drone. When the transport mobility means includes a flight function, the transport mobility means can take off directly through a vertiport on the building roof or can approach any point of a building after landing.

Effects which may be obtained from the present disclosure will not be limited to only the above described effects. Furthermore, other effects which are not described herein will become apparent to those skilled in the art to which the present disclosure pertains from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a schematic diagram of an interface system between a building and a transport mobility means according to an exemplary embodiment of the present disclosure;

FIG. 2, FIG. 3, FIG. 4, FIG. 5, FIG. 6, and FIG. 7 are diagrams illustrating the configuration and operation of a sidewall dome assembly of an interface system between a building and a transport mobility means according to an exemplary embodiment of the present disclosure;

FIG. 8, FIG. 9, FIG. 10, FIG. 11, FIG. 12, and FIG. 13 are diagrams illustrating the configuration and operation of a roof dome assembly of an interface system between a building and a transport mobility means according to an exemplary embodiment of the present disclosure;

FIG. 14 is a diagram illustrating an interface system between a building and a transport mobility means according to an exemplary embodiment of the present disclosure; and

FIG. 15, FIG. 16, FIG. 17 and FIG. 18 are diagrams illustrating a guide rail and a loading portion of an interface system between a building and a transport mobility means according to an exemplary embodiment of the present disclosure.

### DETAILED DESCRIPTION OF THE INVENTION

In describing an exemplary embodiment of the present disclosure disclosed in the present specification, if it is determined that a detailed description of the known art related to the present disclosure makes the subject matter of the exemplary embodiment disclosed in the present specification unclear, the detailed description will be omitted. Furthermore, the accompanying drawings are only for easy understanding of the exemplary embodiment disclosed in the present specification, and do not limit the technical idea disclosed in the present specification. Furthermore, it is to be understood that the present disclosure includes all modifications, equivalents, and substitutions included in the spirit and the scope of the present disclosure. The following disclosure is not intended to limit the present disclosure to a specific form or field described herein, and it is to be understood that various alternative aspects and modifications of the present disclosure may be made whether explicitly stated or implied. Those skilled in the art to which the present disclosure pertains will recognize that the forms and detailed matters of the content of the present disclosure may be changed.

The content of the present disclosure is described with reference to specific aspects. However, as understood by those skilled in the art to which the present disclosure pertains, various aspects described herein may be modified or realized in various other ways without departing from the idea and scope of the content of the present disclosure. Accordingly, the following description should be considered as exemplary and is intended to instruct those skilled in the art to which the present disclosure pertains how to make and use various embodiments. It will be understood that the forms shown and described herein are to be considered as representative embodiments. Equivalent elements, materials, processes, or steps may be substituted with those that are typically exemplified and described in the present disclosure. Expressions, such as “including”, “comprising”, “incorporating”, “consisting of”, “have”, and “is”, used to describe the present disclosure should be interpreted in a non-exclusive manner, specifically, as allowing items, elements, or components that are not explicitly described to be displayed. Furthermore, references to the singular should be construed as including references to the plural.

Furthermore, the various embodiments described herein are to be taken in an exemplary and illustrative sense, and should not be construed as limiting the content of the present disclosure. Any reference to joining (for example, attached, affixed, coupled, and connected) is only used to assist in understanding of the present disclosure, and is not intended to limit the positions, directions, or use of the configurations or the methods described herein. Therefore, when references to joining exist, they should be interpreted broadly. Moreover, such references to joining do not imply that two or more elements are directly connected to each other. Additionally, any numeric terms, such as “first”, “second”, “third”, “primary”, “secondary”, “main”, or any other generic or numeric terms, are to be considered only as identifiers to aid in understanding the various elements, forms, modifications, or variations of the present disclosure, and do not imply any limitation on the elements, forms, modifications, or variations, or the order or preference thereof. That is, these expressions may be used to describe various elements, but the elements are not limited by the corresponding expressions. The expressions are only used to differentiate one element from other elements.

The terms “module” and “part” for elements used herein are assigned or used interchangeably for ease of description only and are not intended to have distinct meanings or roles by themselves.

It will be understood that when an element is referred to as being “coupled” or “connected” to another element, it may be directly coupled or connected to the other element or intervening elements may be present therebetween. In contrast, it will be understood that when an element is referred to as being “directly coupled” or “directly connected” to another element, there are no intervening elements present.

Furthermore, a unit or control unit included in names is only a term which is widely used to name a controller that is configured to control vehicle-specific functions, and does not mean a generic function unit.

A controller may include: a communication device for communicating with other controllers or a sensor to control a function in charge; a memory storing operating system or logic instructions and input/output information; and at least one processor performing determination, operation, and decision required for controlling a function in charge.

Any number of components or various components from any of the configurations herein may be included in the disclosure described in the present specification. Components may include any combination of feature parts described herein and may be arranged in any of the various configuration described herein. The concepts of the structure and arrangement of the components of the present disclosure as well as their use and operation may be applied to the specific embodiments described herein as well as any number of embodiments in any combination. Embodiments that include various feature parts in various arrangements will be described below with reference to the accompanying drawings.

Hereinafter, various embodiments described in the present specification will be described in detail with reference to the accompanying drawings. Throughout the drawings, like or similar elements are denoted by the same reference numerals, and a redundant description thereof will be omitted.

An interface system between a building and a transport mobility means according to the present disclosure enables various transport mobility means including vehicles to move along a wall surface, such as an internal wall or an external wall, of a building for joining.

To the present end, a guide rail is provided at the wall surface of the building, and while loaded on a loading portion, a transport mobility means moves and is slid along the wall surface of the building along the guide rail.

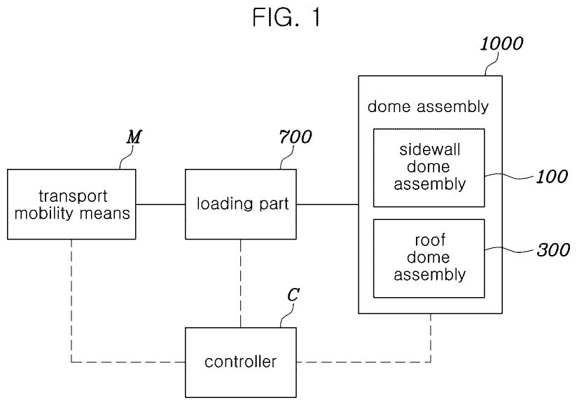

FIG. 1 is a schematic diagram of an interface system between a building and a transport mobility means according to an exemplary embodiment of the present disclosure. According to the present disclosure, a loading portion 700 is slid along a guide rail at a wall surface of the building. Furthermore, a transport mobility means M is loaded on the loading portion 700. Therefore, to move a transport mobility means M to a desired point at the wall surface of the building, a guide rail needs to be provided at the point, thus enabling the loading portion 700 on which the transport mobility means M is loaded to move to the point.

That is, by moving a transport mobility means M with the loading portion 700, a mobility means itself does not need to be provided with a means for moving along the wall surface of the building, and various forms of mobility means may be loaded, allowing the technology to be scalable and applicable to all various forms of mobility means. Examples of the transport mobility means M in the present disclosure may include traditional vehicles, and may include various forms of transport means in addition to traditional vehicles. For example, a single-person electric kickboard, an air mobility means, a drone may be included.

Furthermore, the driving of a transport mobility means M is manually controlled so that the driver may load the mobility means in person on the loading portion 700. After transport, the driver may drive the mobility means in person to enter or exit the building. Furthermore, the controller C may be configured for controlling the transport mobility means M directly so that the mobility means M is loaded on the loading portion 700 automatically rather than manually by the driver and enters or exits the building and moves along the wall surface of the building through the loading portion 700.

To the present end, the controller C may be provided in a form of a server and connected to a transport mobility means through network communication, and the controller C may be used to directly control driving, opening a door, a display, and a speaker of a transport mobility means M.

Furthermore, the controller C is connected to a user or driver's mobile terminal through network communication so that moving, docking, and controlling of a transport mobility means M may be input and results thereof may be informed.

In the meantime, at the wall surface of the building, a plurality of guide rails may be provided with a plurality of forms in different directions. Furthermore, when a plurality of mobility means Ms moves along the wall surface of the building, a central server, which is the controller C, control the movement of the plurality of mobility means, ensuring convenience preventing safety accidents.

To the present end, the controller C manages and is configured to control the motion of a plurality of loading portions 700. To the present end, the controller C is configured to control the movement of each loading portion 700 and power for movement. The controller C is connected to the plurality of loading portions 700 through network communication to establish scheduling for the movement of each loading portion 700, and is configured to control the movement of each loading portion 700 according to the established schedule. Furthermore, to provide the driving force for movement of the loading portion 700, power exchange between the loading portion 700 and a guide rail may be controlled.

In the meantime, a dome assembly 1000 may be provided at various points at the wall surface of the building. The dome assembly 1000 is formed in a dome shape, and is usually provided at any point at the building to protect the point at which the dome assembly is provided. Furthermore, when required, the dome assembly 1000 is opened to receive a transport mobility means M and the loading portion 700 into the inside of the dome assembly 1000. The transport mobility means M received in the internal space of the dome assembly 1000 is protected from rain and wind outside, acting as one space of the building. The dome assembly 1000 functions like a window protruding outwards in a dome shape from the building.

The location at which the dome assembly 1000 is provided is not necessarily limited and may be provided at various wall surface points of the building. Typically, the dome assembly may be provided at an entrance of the building. That is, when the dome assembly 1000 is provided in a manner that protects the entrance of the building, the dome assembly 1000 is configured to perform usually closing and protecting the entrance formed at the building wall surface. Furthermore, when a transport mobility means M enters the inside of the dome assembly 1000, the transport mobility means M may enter the inside of the building through the entrance of the building.

Thus, the system enables an entrance to be freely formed at a wall surface of a building, and through the formed entrance, a transport mobility means M enters the inside of the building from any point at the wall surface of the building. Furthermore, the entrance of the building is normally closed and protected by the dome assembly 1000, and connection to a mobility means is allowed only through the dome assembly 1000, enabling protection from weather outside and management for security.

In the meantime, a transport mobility means M needs to be able to approach the wall surface of the building as well as the roof thereof. On the roof of the building, it is possible to provide a parking lot, and a vertiport for an air mobility means may be provided. Therefore, the mobility of a mobility means needs to be ensured through the roof of the building, so that the dome assembly may be provided at the sidewall of the building as well as the roof of the building. Accordingly, the dome assembly 1000 of the present disclosure may include a sidewall dome assembly 100 and a roof dome assembly 300, and dome assemblies may be provided at various points of the building. That is, the scope of the present disclosure is not limited to the sidewall dome assembly 100 and the roof dome assembly 300, which are mentioned as an exemplary embodiment of the present disclosure, and dome assemblies may be provided at various points.

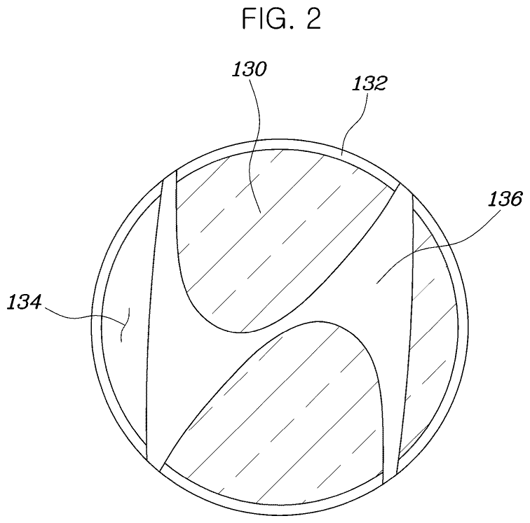

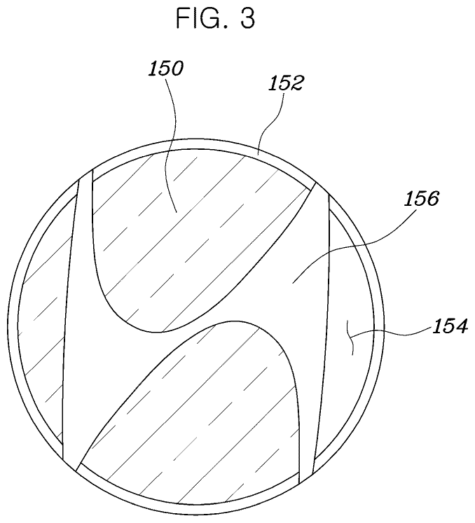

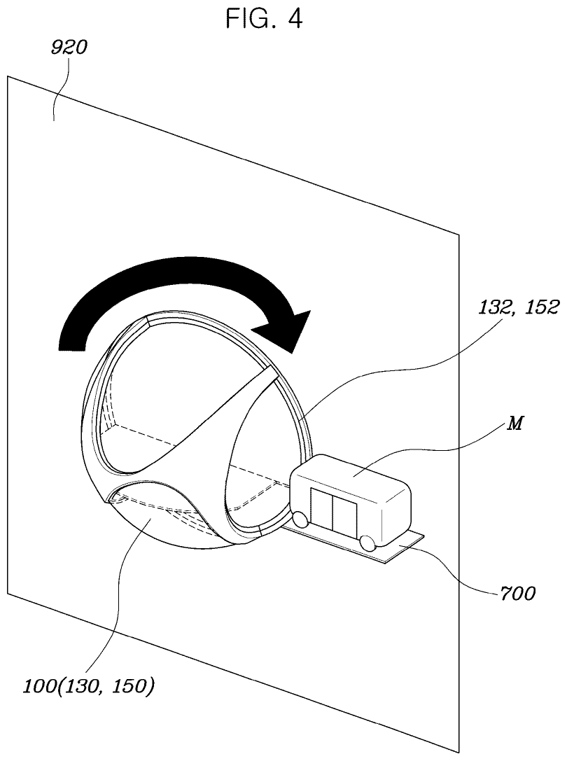

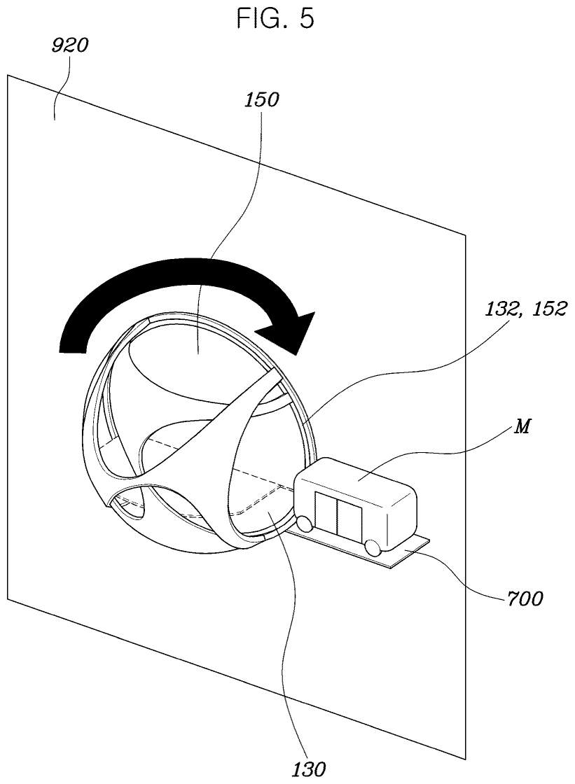

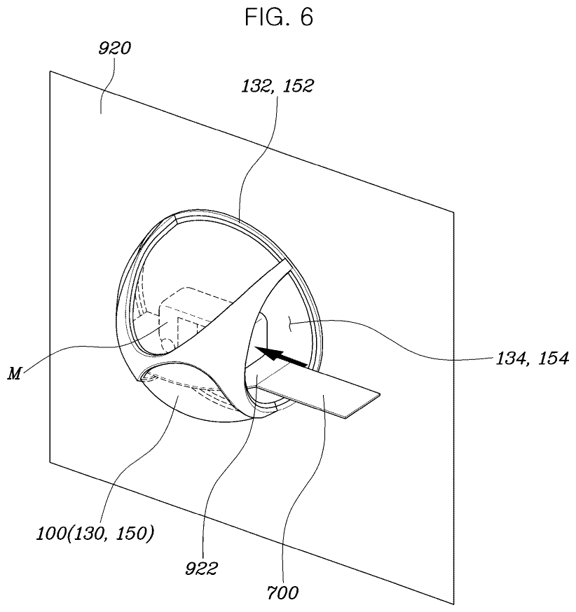

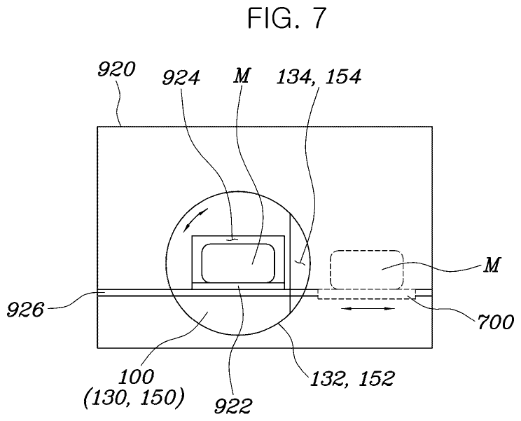

FIGS. 2 to 7 are diagrams illustrating the configuration and operation of a sidewall dome assembly of an interface system between a building and a transport mobility means according to an exemplary embodiment of the present disclosure. The sidewall dome assembly 100 may be provided at various points of the building, but typically at a sidewall 920 of the building as shown in FIG. 4. Furthermore, the sidewall dome assembly 100 may be provided at both an internal sidewall and an external sidewall of the building. Even if the building is not in a quadrangular box shape, but rather a three-dimensional shape with no distinction between inside and outside, the dome assembly may be provided at various wall surfaces.

The sidewall dome assembly 100 provided at the sidewall 920 of the building may be configured through the dome portion shown in FIGS. 2 and 3. The dome assembly of the present disclosure is provided at a wall surface of the building to be positioned on the path of a guide rail, and includes a plurality of dome portions that are joined together in an overlapping manner and rotate relatively. Furthermore, each dome portion includes an opening portion. When the opening portions of the plurality of dome portions are aligned according to the rotation position, the dome assembly is opened through the aligned opening portions. The loading portion and the transport mobility means enter the internal space of the dome assembly through the aligned opening portions.

The dome assembly shown in FIGS. 2 and 3 is a sidewall dome assembly, and the sidewall dome assembly includes a plurality of dome portions that include the same shape and different sizes. FIG. 2 shows one of the dome portions, a first dome portion 130, and FIG. 3 shows the other, a second dome portion 150. The first dome portion 130 and the second dome portion 150 include a similar hemisphere shape, but have different radii forming the respective domes, and are allowed to rotate relatively when overlapping each other. Furthermore, the first dome portion 130 and the second dome portion 150 may normally function as external windows at the building entrance when made of a transparent material, such as glass, plastic, or reinforced plastic. The first dome portion 130 and the second dome portion 150 may be provided with frames 136 and 156 forming exoskeletons. The first dome portion 130 and the second dome portion 150 may function as a brand advertisement if the frames 136 and 156 are formed in the shape of a mark representing a trademark when the two dome portions are aligned. The illustrated trademark is an H-shaped trademark. When the frames match each other, the frames appear to form the H mark from the outside thereof. When the frames cross each other, the frames appear to be crossed H marks. Accordingly, whether the opening portions of the dome assembly are aligned may be checked from the outside thereof depending on whether the marks match. Although the illustrated trademark of the H shape is shown as an exemplary embodiment of the present disclosure, it will be appreciated that any various shapes of trademarks may be applicable.

The respective dome portions are formed with the opening portions 134 and 154 open to one side, and the circular lower portion of each of the dome portions is joined to the external wall of the building. The respective dome portions rotate in place at the wall surface of the building as the circular lower portions 132 and 152 thereof rotate. The rotation of the dome portions enables the circular lower portions to be rotated by various means, such as a motor, and hydraulics. For example, when a motor is provided in the building and a pinion gear is provided and an annular rack gear is formed at the circular lower portions of the dome portions, the motor of the building runs to rotate the dome portions in place. Furthermore, any rotating mechanisms of various means, such as a linear motor formed in an annular shape, a hydraulic mechanism, an electromagnet, and a solenoid, may be applicable. Furthermore, a motor or a hydraulic mechanism may be provided in the building or at the dome portions.

The first dome portion and the second dome portion of FIGS. 2 and 3 are provided overlapping each other to form the dome assembly of FIG. 4.

FIG. 4 shows that while loaded on the loading portion 700, a transport mobility means M is slid toward the dome assembly from a point spaced apart from one side of the sidewall dome assembly 100. In the instant state, the opening portions 134 and 154 of the first dome portion 130 and the second dome portion 150 are arranged crossing each other, and the sidewall dome assembly 100 is in a closed state.

In the instant case, when the transport mobility means M is allowed to dock, the first dome portion 130 and the second dome portion 150 of the dome assembly rotate relatively as shown in FIG. 5. Furthermore, as shown in FIG. 6, the opening portions 134 and 154 of the first dome portion 130 and the second dome portion 150 are rotated to align and the internal space of the dome assembly is opened, and the loading portion 700 and the transport mobility means M enters the internal space of the dome assembly through the open opening portions. Upon entry, a stepping plate 922 may be pulled out at the building entrance, and the transport mobility means M may be driven to move from the loading portion 700 to the stepping plate 922. Alternatively, the loading portion 700 may entirely enter the internal space of the dome assembly. After the transport mobility means M enters the internal space of the dome assembly, the loading portion 700 is withdrawn and the first dome portion 130 and the second dome portion 150 are rotated, so that the respective opening portions 134 and 154 are rotated to cross each other again. Accordingly, the dome assembly 100 may be closed while including the transport mobility means M therein.

In the instant case, the building and the transport mobility means M are spatially connected through an entrance 924 of the building. The transport mobility means M may be more actively driven into the inside of the building to move, and the internal space of the mobility means may form one space of the building.

FIG. 7 is a conceptual diagram illustrating the present series of processes for reference, so a detailed description thereof will be omitted as all relevant descriptions are provided above.

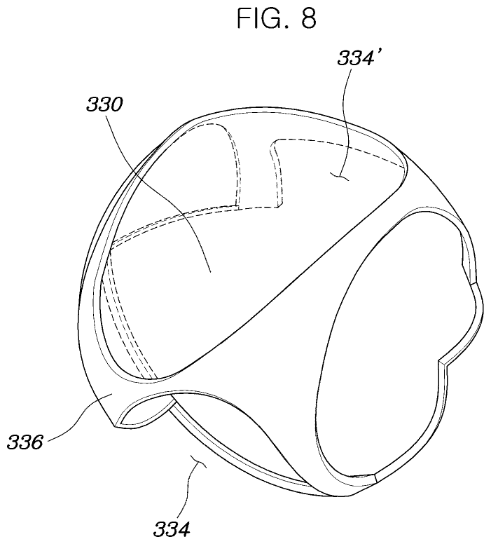

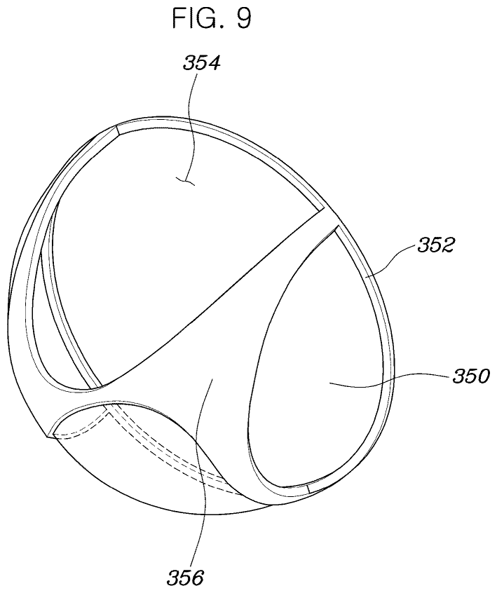

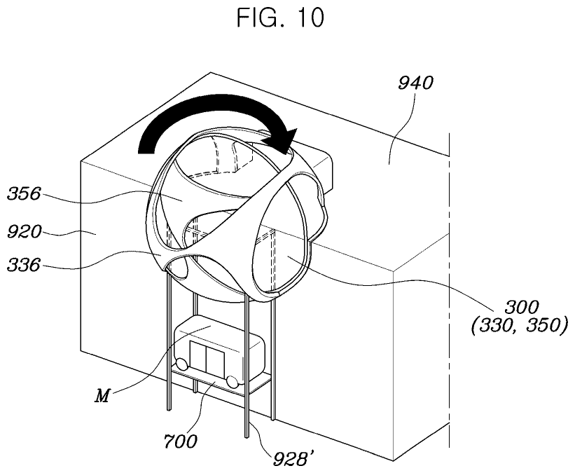

FIGS. 8 to 13 are diagrams illustrating the configuration and operation of a roof dome assembly of an interface system between a building and a transport mobility means according to an exemplary embodiment of the present disclosure.

FIGS. 8 and 9 show a fixed dome portion 330 and a rotating dome portion 350 forming the roof dome assembly 300. The rotating dome portion 350 includes an open hemisphere shape, and the fixed dome portion 330 includes a turned open shape. The roof dome assembly 300 is shaped to cover the top portion of the sidewall and the roof of the building together, so that the fixed dome portion 330 includes the turned open shape. Furthermore, a mobility means comes and goes between the sidewall 920 and the roof 940 of the building through the roof dome assembly 300, so that the fixed dome portion 330 is open to the roof through a roof opening portion 334′ facing the roof and is open to the sidewall through a sidewall opening portion 334 at the lower position.

The rotating dome portion 350 is joined to the fixed dome portion 330 in an overlapping manner. When the rotating dome portion 350 rotates in place and the sidewall opening portion 334 of the fixed dome portion 330 and the opening portion 354 of the rotating dome portion 350 are aligned, the internal space is opened toward the sidewall of the building and the mobility means is allowed to approach from the sidewall into the inside of the dome assembly. Furthermore, the open state to the roof of the building is always maintained through the roof opening portion 334′, so that the mobility means inside the roof dome assembly 300 is allowed to be driven to the roof of the building and discharged at any time.

In the meantime, the guide rail include a horizontal rail 926 and a vertical rail. The horizontal rail 926 includes the shape of a groove recessed in the wall surface of the building, and one side of the loading portion 700 is slid along the horizontal rail while inserted into the horizontal rail 926. Furthermore, the vertical rail includes a plurality of rail pipes 928′ spaced apart from the wall surface of the building. The plurality of rail pipes 928′ may be arranged spaced apart from each other around the loading portion 700 and may be connected to the loading portion 700.

FIGS. 10 to 12 show the rail pipes 928′, and FIG. 13 shows the horizontal rail and the rail pipes 928′ together.

The transport mobility means M is loaded on the loading portion 700, and the loading portion 700 is laterally slid along the horizontal rail 926 and moves into the internal space of the sidewall dome assembly 100. Furthermore, in the sidewall dome assembly 100, the loading portion 700 moves upwards along the rail pipes 928′. The loading portion 700 moves upwards and the rotating dome portion 350 of the roof dome assembly 300 rotates and the sidewall opening portion 334 of the fixed dome portion 330 and the opening portion 354 of the rotating dome portion are aligned, the loading portion 700 and the transport mobility means M enters the internal space of the roof dome assembly 300. Furthermore, the transport mobility means M is allowed to move to the roof 940 of the building through the roof opening portion 334′.

The rail pipes and the loading portion are connected by various technical means, such as a motor and gear assembly method, a linear motor, a hydraulic mechanism, a solenoid, and an electromagnet, so that the loading portion is slid upwards and downwards along the rail pipes. The control of movement of the loading portion may be performed by the controller, and movement commands of the controller may be provided by a provided logic or directive commands through a mobile terminal of a user.

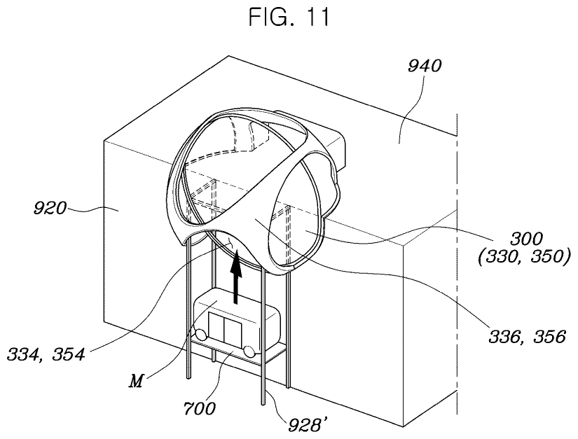

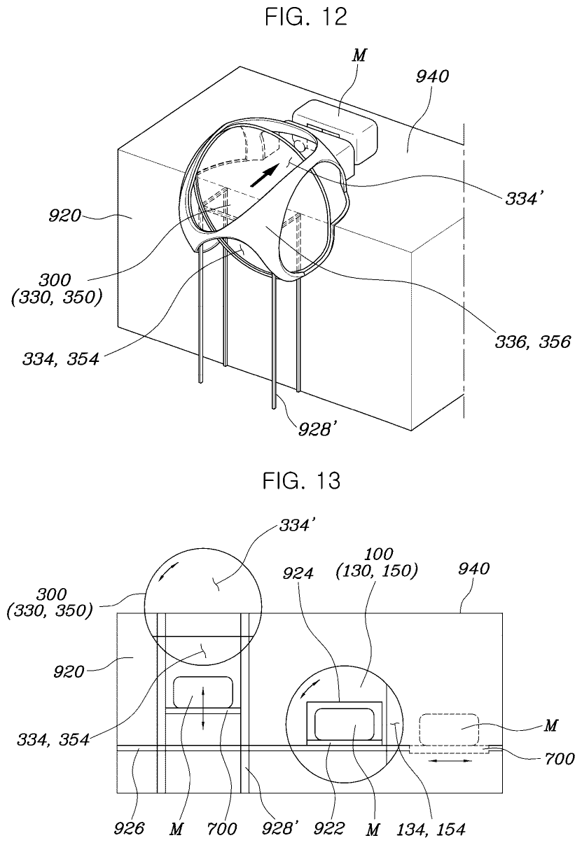

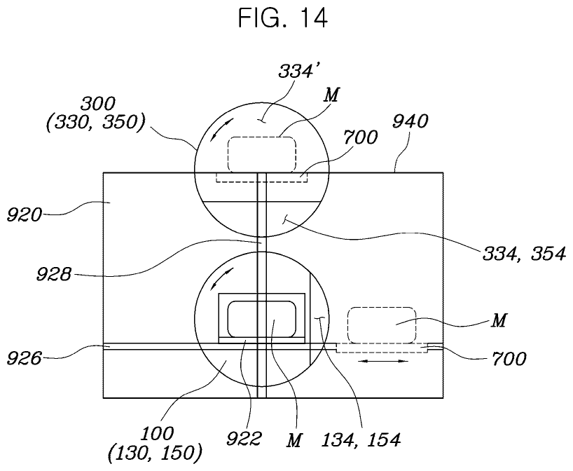

FIG. 14 shows that the guide rail includes the horizontal rail 926 and the vertical rail 928, the horizontal rail 926 and the vertical rail 928 include the shape of grooves recessed in the wall surface of the building, the horizontal rail 926 and the vertical rail 928 intersect each other, and one side of the loading portion 700 is slid while inserted into the horizontal rail 926 or the vertical rail 928.

the horizontal rail 926 and the vertical rail 928 are rails in a side-recessed groove shape. Furthermore, the horizontal rail 926 and the vertical rail 928 intersect. An insertion portion 720 is formed on one side of the loading portion 700, and the insertion portion 720 includes a moving gear which is connected to each of the rails and capable of moving along the rails. The moving gear may be in the shape of a pinion gear.

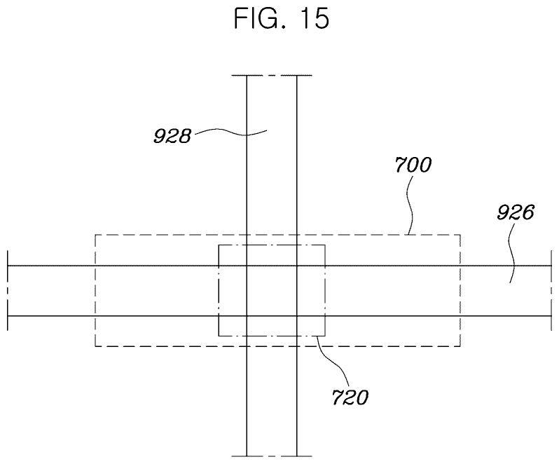

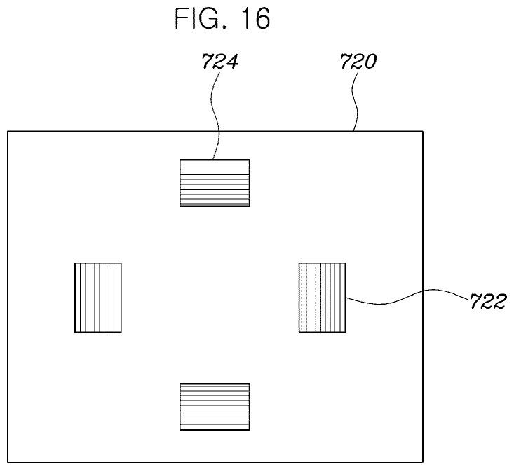

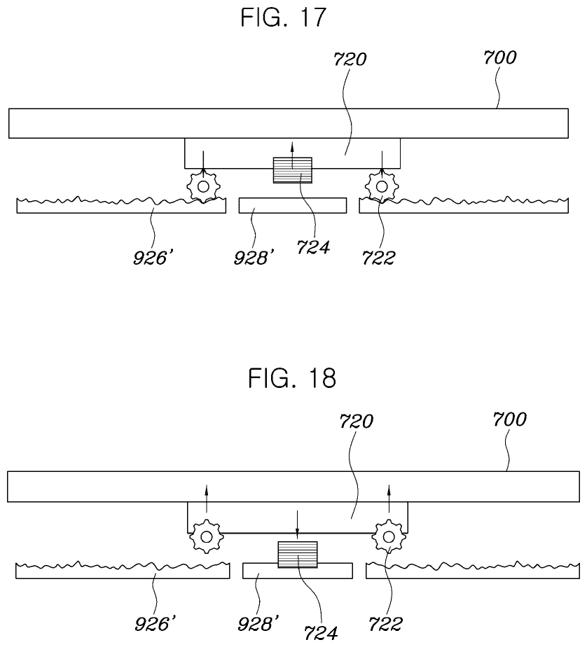

Furthermore, at the bottom surface of the groove of each of the rails, a rack gear may be formed. The insertion portion 720 is inserted into the grooves of the rails. FIG. 15 shows that the point at which the vertical rail 928 and the horizontal rail 926 intersect, the insertion portion 720 of the loading portion 700 is inserted at the intersection point. In the instant state, as shown in FIG. 17, the pinion gear 722 of the insertion portion descends and engages a rack gear 926′ formed in the groove of the horizontal rail 926, and the pinion gear 724 corresponding to the vertical rail 928 rises. In the instant case, the pinion gear 722 corresponding to the horizontal rail 926 is rotated, and the loading portion 700 is slid along the horizontal rail 926.

Furthermore, as shown in FIG. 18, the pinion gear 724 of the insertion portion 720 descends and engages the rail pipe 928′ formed in the groove of the vertical rail 928, and the pinion gear 722 corresponding to the horizontal rail 926 rises. In the instant case, the pinion gear 724 corresponding to the vertical rail 928 is rotated, and the loading portion 700 is slid along the vertical rail 928.

That is, the loading portion 700 may be slid as the pinion gear on the corresponding rail side is driven. When the loading portion 700 is positioned at the intersection point of the rails, the type of the engaged pinion gear is switched and the loading portion 700 may be slid along a different rail in a different direction thereof.

The present configuration allows a transport mobility means to move in a desired direction at the sidewall of the building. When the transport mobility means meets the sidewall dome assembly, the transport mobility means enters the building through the corresponding entrance of the building or is discharged in a different direction to move continuously. In the roof dome assembly, the transport mobility means may move to the roof of the building. In the meantime, the described and shown embodiment shows a combination of a pinion gear and a rack gear, but sliding may be performed by other various means, such as a linear motor, and a hydraulic mechanism.

According to the present disclosure, an interface system between a building and a transport mobility means enables various types of transport mobility means to move at a sidewall and the roof of a building, enables spatial connection with the building at a desired point, and enables a user to transfer to various mobility means at a desired point of the building.

Although a particular embodiment of the present disclosure has been described for illustrative purposes, those skilled in the art to which the present disclosure pertains will appreciate that various modifications, additions, and substitutions are possible, without departing from the technical idea of the disclosure as disclosed in the accompanying claims.

What is claimed is:

1. An interface system between a building and a transport mobility means, the interface system comprising:
a guide rail disposed at a wall surface of the building;
a loading portion on which the transport mobility means is loaded, the loading portion configured to be slid along the wall surface of the building along the guide rail; and
a dome assembly disposed at the wall surface of the building to be positioned on a path of the guide rail, and including a plurality of dome portions that are overlapped and joined together and rotate relatively,
wherein the plurality of dome portions include respective opening portions, and based on that the opening portions of the plurality of dome portions are aligned according to a rotation position of the opening portions, the loading portion and the transport mobility means enter an internal space of the dome assembly through the aligned opening portions.

2. The interface system of claim 1, wherein the loading portion is in a shape of a pallet supporting the transport mobility means, and is connected to the guide rail by a rack and a pinion so that the loading portion is slid along the guide rail.

3. The interface system of claim 1, wherein the guide rail includes a groove recessed in the wall surface of the building.

4. The interface system of claim 1, wherein the dome assembly is disposed at a point at which a plurality of guide rails intersect.

5. The interface system of claim 1, wherein the plurality of dome portions included in the dome assembly rotate relatively around a same rotation axis.

6. The interface system of claim 1, wherein the plurality of dome portions forming the dome assembly overlapped to each other include different radii and joined to the wall surface.

7. The interface system of claim 1, wherein the plurality of dome portions forming the dome assembly are in a shape of hemispheres, and the opening portions are disposed at sides of the dome portions.

8. The interface system of claim 1, wherein based on that the plurality of dome portions rotate relatively to make directions of the opening portions cross each other, the internal space of the dome assembly is closed.

9. The interface system of claim 1, wherein at the wall surface of the building at which the dome assembly is provided, an entrance of the building is disposed.

10. The interface system of claim 9, wherein based on that the transport mobility means is positioned in the internal space of the dome assembly, the transport mobility means is allowed to move into or out of the building through the entrance of the building.

11. The interface system of claim 1, wherein the guide rail includes a horizontal rail including a groove recessed in the wall surface of the building, and one side of the loading portion is slid along the horizontal rail while inserted into the horizontal rail.

12. The interface system of claim 1, wherein the guide rail includes a vertical rail, and the vertical rail includes a plurality of rail pipes spaced apart from the wall surface of the building, and the plurality of rail pipes are disposed spaced apart from each other around the loading portion and connected to the loading portion.

13. The interface system of claim 1, wherein the guide rail includes a horizontal rail and a vertical rail, and the horizontal rail includes a groove recessed in the wall surface of the building, and one side of the loading portion is slid along the horizontal rail while inserted into the horizontal rail.

14. The interface system of claim 1, wherein the guide rail includes a horizontal rail and a vertical rail, and the vertical rail includes a plurality of rail pipes spaced apart from the wall surface of the building, and the plurality of rail pipes are disposed spaced apart from each other around the loading portion and connected to the loading portion.

15. The interface system of claim 1, wherein the guide rail includes a horizontal rail and a vertical rail, and the horizontal rail and the vertical rail include grooves recessed in the wall surface of the building, and the horizontal rail and the vertical rail intersect each other, and one side of the loading portion is slid while inserted into the horizontal rail or the vertical rail.

16. The interface system of claim 1, wherein the dome assembly is disposed to span a sidewall and a roof of the building together at an edge point of the roof of the building.

17. The interface system of claim 16, wherein the dome assembly includes a roof opening portion toward the roof of the building, and the transport mobility means is allowed to move from the internal space of the dome assembly to the roof through the roof opening portion.

18. The interface system of claim 16, wherein the plurality of dome portions include a fixed dome portion fixed at the building and a rotating dome portion rotatable while overlapped with the fixed dome portion.

19. The interface system of claim 18, wherein the fixed dome portion is disposed to cover the sidewall and the roof of the building together, and includes a sidewall opening portion toward the sidewall of the building and a roof opening portion toward the roof of the building.

20. The interface system of claim 19, wherein the rotating dome portion is in a shape of a hemisphere of which a side includes an opening portion, and based on that the opening portion of the rotating dome portion and the sidewall opening portion of the fixed dome portion are aligned, the transport mobility means is allowed to enter the internal space of the dome assembly from the sidewall of the building.
